(19) United States
(12) Patent Application Publication
(10) Pub. No.: US 2017/0181559 A1
(43) Pub. Date: Jun. 29, 2017

(54) DELIVERY FREIGHT DEPOSIT BOX AND METHOD FOR RECEIVING DELIVERY FREIGHT USING THE SAME AND METHOD FOR CERTIFICATTING PASSWORD

(71) Applicant: KD High Tech Co., Ltd., Gyeonggi-do (KR)

(72) Inventor: Je Sun Lee, Incheon (KR)

(21) Appl. No.: 15/308,762

(22) PCT Filed: Apr. 25, 2016
(86) PCT No.: PCT/KR2016/004307

§ 371 Date: Nov. 3, 2016

(30) Foreign Application Priority Data
Apr. 27, 2015 (KR) 10-2015-0058644

(51) Int. Cl. A47G 29/14; G07F 7/06; G06Q 10/08; E05B 47/00; G07C 9/00; G06Q 50/28; H04W 12/06

(52) U.S. Cl. CPC A47G 29/141; G06Q 50/28; G07F 7/069; H04W 12/06; E05B 47/0001; G07C 9/00087; G06Q 10/0832; G06Q 10/0833; A47G 2029/149; E05B 2047/0071

(57) ABSTRACT

A parcel box includes: an input device via which a password can be entered; a memory storing a user's terminal number and a dummy phone number; a communications module sending the password entered via the input device to the terminal via a wired/wireless communications network; and a controller releases a locking mechanism upon receiving an authentication signal from the terminal.

### TECHNICAL FIELD

The present disclosure relates to a parcel box and, more specifically, to a parcel box with a wired/wireless communications mobile device and a method of receiving parcels using the same.

### BACKGROUND ART

Home delivery service is carried out in such a manner that a merchant issues a request to deliver an item at a location within the service area, and then a delivery person comes to take the item and delivers it to the residence of a purchaser.

Typically, the item is delivered to the recipient who ordered it or someone associated with the recipient. However, the delivery person gets in trouble when the recipient or someone else is absent. For an apartment, the delivery person may leave the item in the security office or the maintenance room. However, when there is no one to receive the item, the delivery person has to visit again and again. In addition, the recipient has to wait for the item, which is inconvenient.

On the other hand, there are also many crimes conducted by someone intruding into home as being disguised as a delivery person. Accordingly, it is also required to a solution to eliminate the possibility of such crimes. Accordingly, what is required is a parcel delivery system that allows a recipient to receive a parcel even in her/his absence and to receive a parcel safely without facing a delivery person even when the recipient is present at home or in the office.

There are some patent applications on unmanned delivery service. For example, Patent Document 1 discloses an unmanned parcel box system, which includes: a storage box that has unique identification information and is opened upon receiving a password via local area wireless communications; a smart terminal that transmits a signal to request a password containing the identification information and a phone number via a network to receive the password and inputs the received password to the storage box via local area communications; and an unmanned management server that stores the phone number of the smart terminal, the identification information and the password of the storage box. The management server determines whether the phone number contained in the signal is identical to a previously stored phone number of the smart terminal when the signal is received from the smart terminal, and, if so, searches the password based on the identification information contained in the signal to send it to the smart terminal.

Unfortunately, the system still requires the management server, and thus there is the shortcoming in that it is costly to install and maintain the system.

(Patent Document 1) Korean Laid-Open Patent Publication. No. 10-2015-0020926 (published on Feb. 27, 2015)

### DISCLOSURE

### Technical Problem

It is an aspect of the present disclosure to provide a parcel box that is capable of directly communicating with a recipient's terminal and of opening/closing its door pursuant to the instruction from the recipient by introducing the internet of things (IoT) technology, and a method of receiving a parcel.

### Technical Solution

In accordance with one aspect of the present disclosure, a parcel box includes a storage space, a door for closing/opening the storage space, and a locking mechanism for locking the door. The parcel box may include: an input device via which a password can be entered; a memory storing a user's terminal number and a dummy phone number; a communications module sending the password entered via the input device to the terminal via a wired/wireless communications network; and a controller releases a locking mechanism upon receiving an authentication signal from the terminal.

The parcel box may further include a display device on which the information on the parcel box is displayed, and a video recorder starting recording when a motion is detected in the vicinity of the parcel box.

The memory may further store a shipping number. The controller may control the display device so that a message prompting to enter a shipping number is displayed on the display device if the authentication signal is not received within a predetermined period of time. When the shipping number is entered, the controller may determine whether the entered shipping number is identical to the stored shipping number and control the locking mechanism so that it is released if the numbers are identical to each other.

The controller may create a new password when the locking mechanism is released and then engaged again.

In accordance with another aspect of the present disclosure, a method of receiving a parcel using a parcel box includes: receiving a password; sending the received password to a previously registered terminal via a wired/wireless Internet; and releasing a locking mechanism upon receiving an authentication signal from the registered terminal.

The method may further include: creating a new password when the locking mechanism is released and then engaged again; and sending the created password to a registered terminal.

The authentication signal may be a signal that is generated in a registered terminal and is entered by a user after the user checked the received number, or may be a signal that the terminal has generated by itself if the numbers are identical to each other.

The method may include receiving a shipping number if no authentication signal is received within a predetermined period of time since the password is sent, and comparing the entered shipping number with the stored shipping number to generate the authentication signal if the numbers are identical to each other.

In accordance with yet another aspect of the present disclosure, a method of authenticating a password, wherein an authentication password is sent from a parcel box comprising a wire/wireless communications module to a mobile terminal and the authentication password is authenticated in the mobile terminal, includes: receiving a password via the Internet; determining whether the received password is identical to a predetermined password stored in the mobile terminal; displaying that the password is received if it is determined that the passwords are identical to each other; and sending an authentication signal to the parcel box upon receiving the authentication signal from a user.

The method may include: comparing the received password with the stored predetermined password if no authentication signal is received from the user within a predetermined period of time; and sending the authentication signal to the parcel box if it is determined that the passwords are identical to each other.

The authentication number may be the phone number of the mobile terminal or a dummy phone number.

### Advantageous Effects

According to an exemplary embodiment of the present disclosure, a recipient can receive a parcel safely even in her/his absent without missing it.

In addition, according to an exemplary embodiment of the present disclosure, a recipient can receive a parcel more safely by using a dummy phone number or a shipping number that is not known to anyone but the delivery person and the recipient.

Further, according to an exemplary embodiment of the present disclosure, a parcel storage system does not require any additional server and thus can be established at a low cost.

Moreover, according to an exemplary embodiment of the present disclosure, a group of parcel boxes can be implemented, such that if a number of users are registered with a single parcel box, only the actual recipient can check the reception of the parcel and authenticate the password.

### DESCRIPTION OF DRAWINGS

FIG. 1 is a block diagram of a parcel storage system according to an exemplary embodiment of the present disclosure.

FIG. 2 is a block diagram of a parcel box according to an exemplary embodiment of the present disclosure.

FIG. 3 is a flow chart for illustrating a method for receiving a parcel box using a parcel box according to an exemplary embodiment of the present disclosure.

FIG. 4 is a flow chart for illustrating a method of authenticating a password according to an exemplary embodiment of the present disclosure.

* Description of reference numerals*

| | |
|---|---|
| 100: parcel box | 200: mobile terminal |
| 110: input device | 120: communications module |
| 130: memory | 140: locking mechanism |
| 150: display device | 160: video recorder |
| 170: alarm signal generator | 180: power supply |
| 190: controller | |

### BEST MODE

Embodiments of the present disclosure will now be described in detail with reference to the accompanying drawings. However, it should be noted that the scope of the present disclosure is not limited to the embodiments set forth herein and those skilled in the art would easily accomplish retrogressive inventions or other embodiments that fall within the scope of the present disclosure by adding, modifying and eliminating elements.

The terms or words used in the specification and claims shall not be construed merely in a conventional and dictionary definition but shall be construed in a meaning and concept corresponding to the technical idea of the present disclosure based on the principle that an inventor is allowed to properly define the concepts of terms in order to describe his or her invention in the best way.

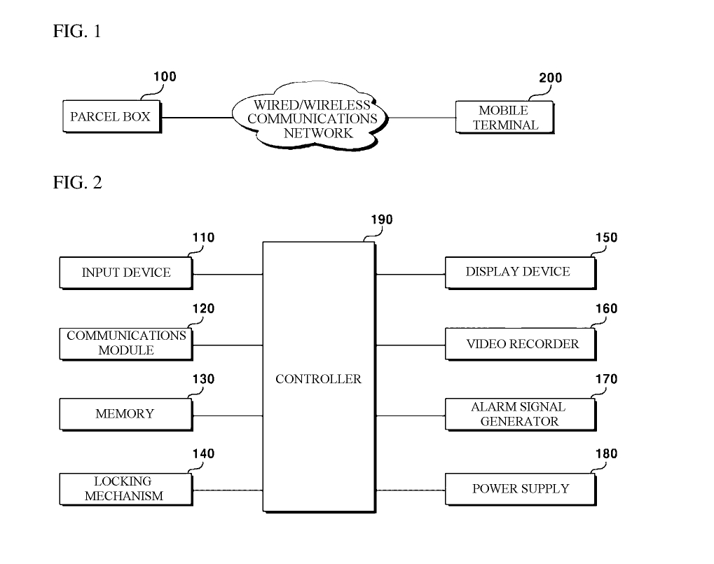

FIG. 1 is a block diagram of a parcel storage system according to an exemplary embodiment of the present disclosure. FIG. 2 is a block diagram of a parcel box.

The parcel storage system according to the exemplary embodiment of the present disclosure includes a parcel box 100 and a mobile terminal 200.

The parcel box 100 includes an input device 110, a communications module 120, a memory 130, a locking mechanism 140, a display device 150, a video recorder 160, an alarm signal generator 170, a power supply 180, and a controller 190.

The input device 110 may be a keypad, for example, and may be used to enter passwords for opening/closing the door and various types of information. Herein, the passwords include five kinds of passwords as described below. The first one is a password previously set by a recipient (hereinafter referred to as “preset password”), such as a recipient's phone number, a dummy phone number for safe delivery, or a shipping number. If there is no item in the parcel box, the user may open the parcel box with this password. The second one is a password entered by a delivery person by using the input device 110 so that she/he is permitted to open the door of the parcel box (hereinafter referred to as “authentication password”). The third one is a password that is stored in a recipient's terminal and used to determine whether the password entered by a delivery person is correct (hereinafter referred to as “a predetermined password”). The fourth one is a password that is newly created by the controller 190 after the first delivery is completed (hereinafter referred to as “reception password”), which will be described in detail below. This password is used for a user of the parcel box, i.e., the recipient to open the parcel box in which a parcel is stored. The fifth one is a password that is used to return a parcel as the parcel is defective or the recipient has changed her/his mind (hereinafter referred to as “return password”). The user may send this password to the seller from whom she/he has ordered the item or to the delivery company so that a delivery person can open the parcel box with this password.

The communications module 120 is connected to the Internet via a wired/wireless communications network and transmits the authentication password entered by a delivery person with the input device 110 to a previously registered terminal. The registered terminal may be a recipient's mobile terminal. If there is a plurality of registered terminals, the authentication password entered from the input device 110 is transmitted to all of the terminals. According to an exemplary embodiment of the present disclosure, by employing the communications module capable of being connected to the Internet, such as a wired/wireless LAN card, data may be transmitted via the Internet, instead of sending a SMS message to a recipient. Accordingly, in addition to transmitting information such as an authentication password, video recorded by the video recorder 160 may also be transmitted in real-time via the communications module 120.

For example, a recipient's phone number is stored in the memory 130 via the input device 110 before a delivery person visits. That is, the phone number of the registered terminal is stored. For example, when a single parcel box is shared by a number of users, a number of phone numbers may be stored in the memory 130. In addition, predetermined passwords including a dummy phone number and a shipping number as well as a reception password or a return password may be stored, as will be described in detail below.

The locking mechanism 140 is a device that closes and opens the door of the parcel box. It opens the door upon receiving a signal to open the door under the control of the controller 190, and it locks the door automatically when the door is closed. When an authentication password (e.g., a recipient's phone number or a dummy phone number) entered by a delivery person is sent to a recipient's terminal, the recipient checks it. If the received authentication password is identical to the recipient's phone number or the dummy phone number that was notified at the time of ordering the item (e.g., by leaving a memo on the web page), the recipient sends an instruction to open the door to the parcel box 100. Then, the parcel box 100 receives it via the communications module 120 to open the door.

The display device 150 displays information as to whether there is a parcel in the parcel box 100, e.g., such messages as “occupied” or “vacant.” The display device 150 may be an LCD panel, for example. The display device 150 may be fabricated as a touch screen, with the input device 110 thereon. The display device 150 may also display a variety of messages as well as such messages. For example, if a delivery person receives no signal to open the door after a predetermined period of time elapsed since she/he has sent the authentication password to the registered terminal, the display device may display a message saying “Press the star (*) button twice and enter the shipping number.” When a shipping number is entered, the controller 190 compares the entered shipping number with the shipping number stored in the memory 130 to determine whether they are identical to each other. If so, the controller 190 controls the locking mechanism 140 so that it is released.

The video recorder 160 includes a camera module and a storage, and captures and records video in the vicinity of the parcel box. In doing so, a message saying “recording” may be displayed with LED lamps, so that a visitor can recognize that the camera is operating. The video recorder 160 may record video only when any person approaches the parcel box or a motion is detected. Once recording is started, the recorded video may be transmitted to the registered terminal in real-time via the communications module 120 to allow the user to see it. Optionally, the controller 190 may start recording or transmit the recorded video to the registered terminal only when an input signal is sent from the input device 110. Further, a sensor is required to sense motions. The sensor may be incorporated in the video recorder 160 or may be disposed as a separate device at a certain location of the parcel box 100. As the video recorder 160 records the situation in the vicinity of the parcel box 100, it is possible to check who is visiting even if the visitor damages the camera.

The alarm signal generator 170 may generate an alarm signal when the password fails more than a predetermined number of times or when someone attempts to open the door forcibly. The alarm signal generator 170 may be a flasher such as an LED lamp, a speaker or the like. When an alarm signal is generated, the communications module 120 may send a signal notifying that the alarm signal has been generated to the registered terminal. The alarm message may be displayed on the display device 150.

The power supply 180 is to supply power necessary for operating the parcel box 100 and may be an external AC power supply or a battery.

The controller 190 controls the overall operation of the parcel box 100 so that the above-described elements can operate.

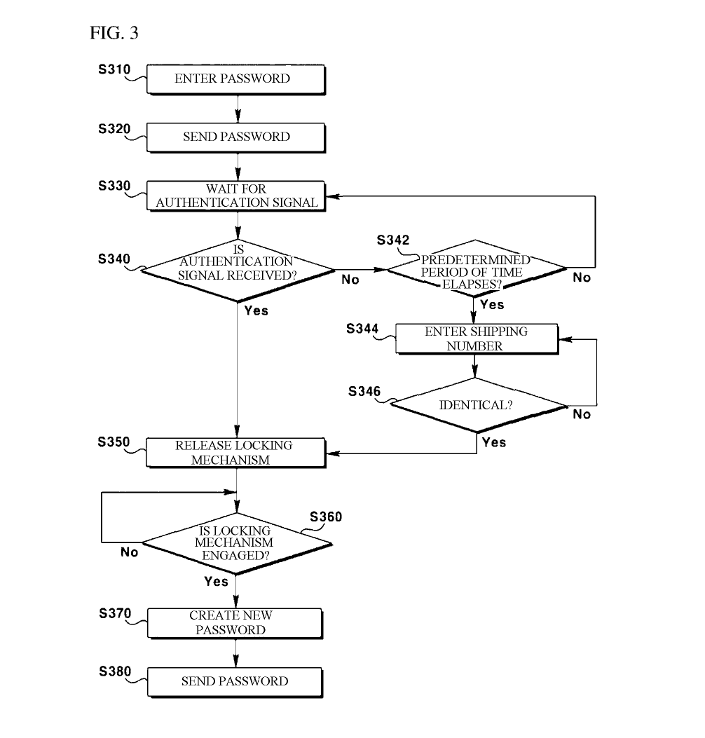

FIG. 3 is a flow chart for illustrating a method of operating a parcel box according to an exemplary embodiment of the present disclosure.

The method of operating a parcel box will be described with reference to FIGS. 2 and 3.

When a delivery person approaches the parcel box 100, the sensor disposed in the video recorder 110 detects the motion, and recording is started. The controller 190 sends a signal notifying that recording is started to a recipient via the communications module 120. Preferably, the signal is sent when an authentication password is sent, which is to be described below. However, this is not limiting. The recipient's phone number is stored in the memory 130 as described above, and thus the signal may be sent to the stored number. If several phone numbers are stored in the memory, the signal may be sent to the several phone numbers.

The delivery person enters an authentication password (e.g., the recipient's phone number or a dummy phone number) via the input device 110 (step S310). As described above, it is desired that the authentication password (e.g., the recipient's phone number or a dummy phone number) is notified to the delivery person in advance by leaving a memo at the time of ordering the item. Once the delivery person enters the authentication password (e.g., the recipient's phone number or the dummy phone number), the controller 190 sends the entered authentication password to the recipient via the communications module 120 (step S320). If several phone numbers are registered as users, the entered authentication password may be sent to all of the several phone numbers. Although not shown in the drawings, when the delivery person enters the recipient's phone number as the authentication password, the authentication password may be sent only at the phone number.

After the authentication password has been sent, the terminal that has received the authentication password performs an authentication process and sends an authentication signal back to the parcel box. The authentication process will be described in detail below. The parcel box 100 waits for receiving the authentication signal after sending the authentication password entered by the delivery person (step S330). Upon receiving the authentication signal (step S340), the lock is released (step S350). If no authentication signal is received due to communications failure or the like, it is determined whether a predetermined period of time has elapsed (step S342). If it is determined that the predetermined period of time has elapsed, a message saying “Enter the shipping number” is displayed on the display device 150. If it is determined that the predetermined period of time has not elapsed yet, it proceeds back to step S330. For example, a message saying “The recipient does not reply. Press the star (*) button twice and enter the shipping number” is displayed on the display device 150, and then the delivery person may check it to enter the shipping number. The predetermined period of time may be set as desired, preferably to twenty to thirty seconds. When the shipping number is entered (step S344), the controller 190 determines whether the shipping number stored in the memory 130 is identical to the entered shipping number (step S346). If it is determined that they are identical to each other, the locking mechanism is released (step S350).

After the locking mechanism is released, the delivery person puts the parcel into the parcel box and closes the door. Then, the locking mechanism 140 is automatically engaged. When the locking mechanism is engaged again, the controller 190 creates a new password (a reception password) to store it in the memory 130 (step S370) and transmits it to the registered terminal (step S380). As mentioned earlier, the reception password may be used later on when the recipient wants to open the door of the parcel box to take out the parcel stored therein. For example, the recipient may open the door as follows: the recipient enters the reception password sent to her/his terminal via the input device 110, and the controller 190 compares the entered reception password with the reception password stored in the memory 130. If it is determined that they are identical to each other, an instruction to open the door is sent to the locking mechanism 140, such that the door can be opened.

Preferably, the parcel box is initialized to be used again after the recipient entered the reception password to open the door. That is, the controller may erase that the preset password and the reception password previously entered by the recipient from the memory so that new passwords can be stored in the memory. It is to be noted that the terminal numbers of the users who use the parcel box should not be erased. In the initialization state, the locking mechanism may not be operated automatically even if the door is closed.

Such processes enables a parcel box for a single user to receive parcels more than twice. Since the locking mechanism is automatically engaged, when the second delivery person visits, she/he can open the parcel box and put a parcel into it by entering an authentication password (e.g., the recipient's phone number or a dummy phone number) according to the same procedure.

When the second delivery person puts the parcel into the parcel box and then closes the door, the locking mechanism 140 is automatically engaged again, and the recipient receives a newly created authentication password in the same manner as described above. When the recipient wants to receive the parcel later on, she/he may enter the newly received authentication password to open the parcel box.

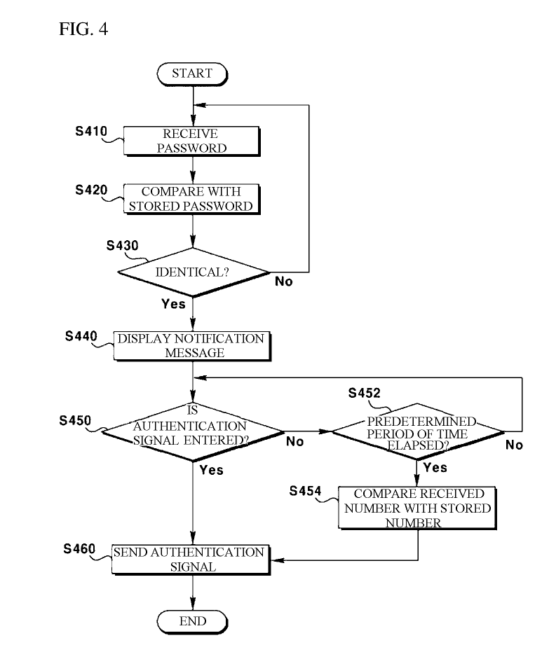

FIG. 4 is a flow chart for illustrating an authentication process taking place in a recipient's mobile terminal that received the password.

Preferably, the mobile terminal is a smartphone on which applications can be installed. A series of procedures to be described below may be implemented with applications.

Initially, an authentication password entered by a delivery person is received (step S410), and the authentication password is compared with a predetermined password stored in the terminal (step S420). As described above, the authentication password may be the recipient's phone number or a dummy phone number. Accordingly, a predetermined password corresponding to the authentication password (e.g., the recipient's phone number or a dummy phone number) has to be stored in the terminal.

It is determined whether the authentication password transmitted to the terminal is identical to the predetermined password stored in the terminal (step S430). If it is determined that they are identical to each other, a notification message is displayed (step S440), otherwise the procedure goes back to the beginning. That is, the notification message is displayed only when the received authentication password is identical to the predetermined password stored in the terminal. For example, a message saying “The password ‘010-1234-5678’ has been received from the parcel box” may be displayed. With this pre-authentication procedure, for a group of parcel boxes (e.g., one or more parcel boxes shared by a plurality of users), an authentication password is sent to the plurality of users, but only the actual recipient checks the authentication password to carry out the authentication process. In this manner, the parcel box according to the exemplary embodiment of the present disclosure may be used for a group of parcel boxes.

When the notification message is displayed, the recipient checks the displayed authentication password and enters an authentication signal. In doing so, in addition to checking the authentication password, the recipient may check video captured by the video recorder to see whether the right delivery person has entered the authentication password. When the authentication signal is entered by the recipient (step S450), the terminal transmits the authentication signal to the parcel box (step S460), and the procedures ends. Optionally, if no authentication signal is entered until a predetermined period of time elapses because the recipient did not check the message or for other reasons (step S452), the terminal authenticates whether the received authentication password is identical to the stored password once again (step S454). If they are identical to each other, the terminal may send the authentication number by itself (step S460), and the procedure ends.

Alternatively, after the predetermined period of time has elapsed in step S452, it may proceed to step S460 while step S454 may be skipped.

Steps S452 and S454 and steps S342, S344 and S346 described above with reference to FIG. 3 may be alternative to each other. That is, the procedure carried out in the parcel box may include steps S342, S344 and S346 while the procedure carried out in the user terminal may omit steps S452 and S454. Alternatively, the procedure carried out in the user terminal may include steps S452 and S454 while the procedure carried out in the parcel box may omit steps S342, S344 and S346.

By performing the above-described authentication procedures, the parcel box according to the exemplary embodiment of the present disclosure may be applied for a group of parcel boxes such as used in an apartment. In such a case, a single parcel box may be shared by a number of users or a user may designate and use two or three parcel boxes. In the latter case, a user may enter her/his box number in a field such as a memo at the timing of ordering an item, so that a delivery person can find the box easily.

For example, where the first parcel box is shared by three persons A, B and C and all the three persons' phone numbers are registered to the first parcel box, when a delivery person enters an authentication password (e.g., the recipient's phone number or a dummy phone number) in the first parcel box, the entered authentication password is sent to all of the three persons. Although the first parcel box sends the entered authentication password to all of the registered users, the application installed in the users' terminals carries out the above-described authentication procedures and displays a notification message only when the entered authentication password is identical to the predetermined password stored in the user's terminal. As a result, only the actual recipient can check the entered authentication password. For example, where user A's phone number is “010-1234-5678” and a delivery person enters “010-1234-5678” as the authentication password, the parcel box sends the number to all of the users A, B and C, but only user A who has the identical number receives it.

In addition, when returning the delivered item due to a defect, the parcel box according to an exemplary embodiment of the present disclosure may be used. An example may be implemented as follows:

(1) Putting an Item To Be Returned In a Parcel Box: A user puts the item in the empty parcel box and closes the door.

(2) Entering a Return Password: The user may enter a return password via the input device. The entered return password may be stored in the memory 130. Alternatively, the user may enter the return password via an application installed in her/his terminal. For example, when a user runs an application on her/his terminal, a tag for returning is displayed. Then, the user clicks the tag to enter the return password, the entered return password is sent to the parcel box to be input to the memory 130. When the return password is stored in the memory, the controller 190 may engage the locking mechanism 140.

(3) Transmitting the Return Password: The password used in step (2) is transmitted to the delivery person. Specifically, a user may leave a memo on the web page of the shop that she/he has ordered the item or directly notify it to the delivery service company, such that the delivery person who is going to take the item can receive the return password finally. For a group of parcel boxes, it is desirable to notify the number of the parcel box in which the item to be returned is stored. This step (3) may be carried out prior to step (2).

(4) Taking the Item To Be Returned: The delivery person enters the received return password in the parcel box to take out the item to be returned. Since a number of passwords may be stored in the memory of the parcel box, it is desirable that a message saying “To enter a return password, press start (*) button twice to enter the password” for example, is displayed on the display, so that the delivery person can recognize she/he is now entering the return password. The controller 190 may compare the entered return password with the return password stored in the memory 130, and may control the locking mechanism 140 so that it is released if the passwords are identical to each other.

5) Initializing: After the correct password is entered so that the locking mechanism 140 is released, the parcel box may be initialized to receive another item or to be used for another item to be returned, as described above.

Thus far, although specific exemplary embodiments of the present disclosure have been described, various modifications may be made without departing from the scope of the present disclosure. Accordingly, the scope of the present disclosure is not construed as being limited to the above-described embodiments but is defined by the appended claims as well as equivalents thereto.

### INDUSTRIAL APPLICABILITY

According to the parcel box and the method of receiving parcels and authenticating passwords using the same according to the exemplary embodiments of the present disclosure, a recipient can receive a parcel safely without missing it even in her/his absence, and can receive a parcel more safely by using a dummy phone number or a shipping number that is not known to anyone but the delivery person and the recipient. In addition, no additional server is required and thus it is possible to establish a safe parcel storage system at a low cost. The parcel box according to the exemplary embodiment of the present disclosure can also be applied to a group of parcel boxes, and if a number of users are registered with a single parcel box, only the actual recipient can check reception of the parcel and authenticate the password. In view of the above, the present disclosure does not merely exhibit technically inventive step over the related art but also has sufficient possibility of making and manufacturing in practice, and thus the present disclosure will have industrial applicability.

1. A parcel box having a storage space and a door for closing/opening the storage space, the parcel box comprising:
a locking mechanism configured to lock the door;
an input device via which an authentication password is entered;
a memory configured to store a number of a terminal of a user who uses the parcel box, a dummy phone number and a shipping number therein;
a communications module configured to carry out bi-directional communications with the user's terminal;
a display on which information on the parcel box is displayed; and
a controller,
wherein the controller is configured to:
send the authentication password entered via the input device to a previously registered terminal via the communications module;
release the locking mechanism if an authentication signal is received from the terminal having received the authentication password within a predetermined period of time since the authentication password has been sent;
display a message prompting to enter a shipping number if no authentication signal is received from the terminal within the predetermined period of time; and
when the shipping number is entered, compare the entered shipping number with a shipping number previously stored in the memory and control the locking mechanism so that it is released if the shipping numbers are identical to each other.

2. The parcel box of claim 1, further comprising:
a video recorder configured to start recording if a motion is detected in the vicinity of the parcel box.

3. The parcel box of claim 1, wherein the controller creates a reception password when the locking mechanism is released and then engaged again.

4. A method of receiving a parcel using a parcel box, the parcel box comprises an input device, a memory, a display device, a communications module, a storage space, a door for opening/closing the door and a locking mechanism for locking the door, the method comprising:
receiving an authentication password via the input device;
sending the received authentication password to a previously registered terminal via the communications module;
releasing a locking mechanism if an authentication signal is received from the registered terminal within a predetermined period of time since the authentication password has been sent;
displaying a message prompting to enter a shipping number if no authentication signal is received within the predetermined period of time;
receiving the shipping number via the input device; and
comparing the entered shipping number with a shipping number previously stored in the memory to release the locking mechanism if the shipping numbers are identical to each other.

5. The method of claim 4, further comprising:
creating a reception password when the locking mechanism is released and then engaged again; and sending the created reception password to a registered terminal.

6. A method of authenticating a password, wherein an authentication password is sent from a parcel box comprising a wire/wireless communications module to a mobile terminal and the authentication password is authenticated in the mobile terminal, the method comprising:
receiving an authentication password via the Internet;
determining whether the received authentication password is identical to a predetermined password stored in the mobile terminal;
displaying that the authentication password is received if it is determined that the passwords are identical to each other; and
sending an authentication signal to the parcel box upon receiving the authentication signal from a user.

7. The method of claim 6, comprising:
comparing the received authentication password with the stored predetermined password if no authentication signal is received from the user within a predetermined period of time; and
sending the authentication signal to the parcel box if it is determined that the passwords are identical to each other.
